(19) United States
(12) Patent Application Publication
(10) Pub. No.: US 2011/0091788 A1
(43) Pub. Date: Apr. 21, 2011

(54) GAS DIFFUSION ELECTRODES COMPRISING FUNCTIONALISED NANOPARTICLES

(75) Inventors: Torsten Ziser, Weinheim (DE); Thomas Früh, Mutterstadt (DE); Domnik Bayer, Heidelberg (DE); Werner Obrecht, Moers (DE); Dieter Melzner, Gottingen (DE); Annette Reiche, Gottingen (DE); Oliver Gronwald, Gottingen (DE)

(73) Assignees: Elcomax GmbH, Munich (DE); Lanxess Deutschland GmbH, Leverkusen (DE); Rhein Chemie Rheinau GmbH, Mannheim (DE)

(21) Appl. No.: 12/967,731

(22) Filed: Dec. 14, 2010

Related U.S. Application Data
(63) Continuation of application No. PCT/EP2009/004354, filed on Jun. 16, 2009.

(30) Foreign Application Priority Data
Jun. 16, 2008 (DE) 10 2008 028 552.8

(51) Int. Cl. H01M 8/04; H01M 8/10

(52) U.S. Cl. 429/481; 429/535

(57) ABSTRACT

The invention relates to a gas diffusion electrode for polymer electrolyte fuel cells having a working temperature of up to 250° C., comprising a plurality of gas-permeable electroconductive layers having at least one gas diffusion layer and one catalyst layer. The catalyst layer contains particles of an average particle diameter in the nanometer range, said particles containing ionogenic groups. The invention also relates to the production of said gas diffusion electrode and to the use of same in high-temperature polymer electrolyte membrane fuel cells.

### CROSS REFERENCE TO RELATED APPLICATIONS

This application is a continuation of PCT/EP2009/004354, filed on Jun. 16, 2009, which claims priority to DE Application No. 10 2008 028 552.8, filed on Jun. 16, 2008, the contents of each being incorporated herein by reference.

### FIELD OF THE INVENTION

The present invention relates to a gas-diffusion electrode for polymer electrolyte fuel cells with an operating temperature up to 250° C. with a plurality of gas-permeable electrically conductive layers, which comprise at least one gas-diffusion layer and one-catalyst layer, wherein the catalyst layer contains particles containing ionogenic groups and having a mean particle diameter in the nanometer range, as well as to the production of the gas-diffusion electrode and use of same in high-temperature polymer electrolyte membrane fuel cells.

### BACKGROUND OF THE INVENTION

Gas diffusion electrodes for use in polymer electrolyte fuel cells are components of a membrane-electrode assembly (MEA). These contain at least two gas-diffusion electrodes, one an anode and one a cathode, which enclose a proton-conducting electrolyte membrane in the form of a sandwich and are contacted on the outside by bipolar plates (see FIG. 1).

Gas-diffusion electrodes for polymer electrolyte fuel cells have multi-layer structure and comprise at least one-gas diffusion layer and one catalyst layer, the latter contacting the polymer electrolyte membrane.

The gas-diffusion layer consists of an electrically conductive paper or fleece, usually on the basis of graphited fibers. It connects bipolar plates and catalyst layer electrically, guides the reaction gases from the bipolar plates into the catalyst layer and transports the product water formed from the catalyst layer into the bipolar plates.

The catalyst layers consist of a porous layer of nanoscale particles on an electrically conductive support material, such as carbon-black particles, on which an electrocatalyst is dispersed.

The tasks of the catalyst layer comprise transporting the hydrogen and oxygen reactants as well as the protons to the electrocatalyst, reacting the reactants, transporting the product water away into the gas-diffusion layer and discharging and supplying electrons. To achieve high efficiency of the MEAs, the components of the catalyst layer must be distributed in the electrode layer in such a way that:
access of the reaction gases to the electrocatalyst and transport of the product water away are ensured,
an electron-conducting connection from the electrocatalyst to the gas-diffusion layer is present, and
a proton-conducting connection exists between electrolyte membrane and electrocatalyst.

On the basis of the different reactions that occur in the anode and cathode chambers of an MEA, the two catalyst layers of an MEA are usually not identical, but instead are adapted in composition and structure to the respective reaction conditions at anode and cathode.

To ensure the proton-conducting connection between electrolyte membrane and electrocatalyst, the catalyst layer contains a proton conductor. U.S. Pat. No. 4,876,115 describes the use of Nafion® or ruthenium dioxide as proton-conducting material, which contacts the surface of the electrically conductive carbon particles as the support of the catalyst material and provides the protons produced by the cell reaction with a proton-conducting connection to the polymer electrolyte membrane.

To ensure access of the reaction gases to the electrocatalyst as well as removal of the product water, the catalyst layer has porous structure. The carbon-black particles usually have a diameter of 10-40 nm. The catalyst particles usually have a diameter of 3-10 nm. In addition, the catalyst layer usually contains polytetrafluoroethylene (PTFE). JP 1994-84797 describes a multi-layer electrode, in which hydrophobic gas channels, which improve the supply to the catalysis centers, are created in the porous electrode structure by incorporation of polytetrafluoroethylene (PTFE). Simultaneously, the mechanical integrity and stability of the body of the electrode are increased, thus leading to improved long-time stability under the given operating conditions. PTFE makes the catalyst layer hydrophobic and functions as a binder. One disadvantage consists in the partial inactivation of the catalyst centers due to coverage with PTFE.

Nafion® is unsuitable as proton-conducting material in gas-diffusion electrodes for use in polymer electrolyte fuel cells in the operating temperature range above 100° C., since it is not stable during continuous operation under these operating conditions.

By virtue of the improved electrode kinetics in conjunction with increased tolerance of the anode catalyst toward carbon monoxide and other catalyst poisons, operation of polymer electrolyte fuel cells at temperatures up to 250° C. is desirable. Thereby the technical outlay for gas purification in the case of use of hydrogen from reformate gas can be greatly reduced. Furthermore, the waste heat of the cell can be used more effectively because of its higher temperature level.

Usually membranes consisting of basic polymers (for example, from polyazoles), to which proton conductivity has been imparted by doping with inorganic acids, are used for operation of polymer electrolyte fuel cells at operating temperatures above 100° C. U.S. Pat. No. 5,525,436 describes the production of membranes doped with phosphoric acid from polybenzimidazole and the use thereof in high-temperature fuel cells. The phosphoric acid also usually used as electrolyte for the electrodes has the disadvantage that it is present in liquid form and fills the pores of the catalyst layer. Access to the electrode catalyst necessitates transport of the process gases through the phosphoric acid. This is made difficult because of the low oxygen solubility and the low diffusion coefficient for oxygen, thus inhibiting the electrode reaction on the cathode side and in turn lowering the power density of these high-temperature polymer electrolyte membrane fuel cells in comparison with the lower-temperature system using Nafion®.

Phosphoric acid is bound only partly by capillary forces in the electrode and therefore is mobile within the membrane-electrode assembly, and this may be the cause of degradation phenomena. Accordingly, the development efforts on the use of a more suitable proton conductor for the catalyst layer must concentrate on increasing the performance of high-temperature polymer electrolyte fuel cells. The content of liquid phosphoric acid should be reduced, or phosphoric acid should be replaced by a solid proton conductor, while at the same time good contact between the catalytic centers on the support material and the electrolyte and the gas phase, accompanied by simultaneous establishment of a mechanically load-resistant composite of the electrode components, should be assured. A further aspect consists in improving the distribution of phosphoric acid in the catalyst layer, and this should be made possible by improved wettability of the catalyst layer.

The tasks of the catalyst layer can be achieved particularly well in thin layers <50 microns, in which all components of the catalyst layer, the electrocatalyst on the carbon-black particles, the proton-conducting material and the binder are present in the form of nanoparticles. The production of thin catalyst layers requires the use of printing processes similar to the ink-jet process, thus imposing special material requirements. The components of the catalyst ink must form a stable suspension and be provided with nanoscale particles whose particle-size distribution is as homogeneous as possible.

WO 01/18894 A2 describes the production and use of gas-diffusion electrodes for operation at temperatures above 100° C. by incorporation of basic polybenzimidazole in the electrode structure for optimized binding of phosphoric acid as the electrolyte. For this purpose the paste or suspension of a support material containing catalyst are applied in a solution of polybenzimidazole (PBI) in dimethylacetamide (DMAc) onto a hydrophobic gas-diffusion layer and a stable electrode layer is produced by removing the solvent. To ensure proton conducting between the catalytic centers and the polymer electrolyte membrane, the electrode layer is then impregnated with an acid (such as phosphoric acid) as a doping agent, in which case polybenzimidazole in its capacity as a basic polymer immobilizes the doping agent and at the same time exerts a binder function on the electrode composite. The electrodes impregnated with phosphoric acid and the polybenzimidazole polymer electrolyte membranes doped with phosphoric acid are hot-pressed to form membrane-electrode assemblies. A disadvantage is that dense layers of polybenzimidazole are produced by this production method on the electrocatalytically active support material, thus greatly reducing the gas permeability in the electrode layer and in turn the accessibility of the fuel gases to the catalyst centers.

WO 2006/005466 A1 solves this problem by loading only part of the particles of the electrically conductive support material with porous, proton-conducting polymers (such as polybenzimidazoles) and thus greatly improving the accessibility of the catalyst for the reaction gases. Because of the partial loading, the binder function is weakened, thus necessitating the addition of binding additives, such as PTFE. The consequence is that, besides the aforesaid partial inactivation of the catalysis centers by coverage with PTFE, the hydrophobic effect of the PTFE limits the wettability of the electrodes for the hydrophilic phosphoric acid doping agent and thus the efficiency of proton conductivity of the electrodes.

US 2007/0166600 A1 discloses electrodes containing amorphous proton-conducting solids consisting of oxides such as B₂O₃, ZrO₂, SiO₂, WO₃, P₂O₅, which can be used in high-temperature fuel cells up to 150° C. The electrolytes are incorporated in ground form into the catalyst layer. Because of the production process, they have a broad particle-size distribution. The size of the proton-conducting particles imposed by the production process reduces effective contacting of the catalyst centers and limits the power density of the system.

Furthermore, the broad size distribution of the particles makes it difficult to process electrode inks by means of printing processes such as inkjet processes, and so the production of sufficiently thin electrode layers cannot be technically achieved in the production process.

None of the aforesaid technical solutions proposed for the area of high-temperature polymer electrolyte membrane electrode assemblies permits the production of a membrane-electrode composite in the sense of a nanodisperse distribution of all components of the catalyst layer with optimally bound catalyst support material and simultaneously improved power density by effective contacting of the active catalyst centers with the electrolyte and with the gas phase for unhindered supply of the reaction gases, in order to improve the gas permeability of the electrocatalyst layer and its wettability for phosphoric acid.

### SUMMARY

The object of the present invention is to provide gas-diffusion electrodes for high-temperature polymer electrolyte fuel cells with improved power density and long-term stability, wherein the catalyst layer has good adherence and proton-conducting binding on a gas-diffusion layer and/or a polymer electrolyte membrane and exhibits durably high stability under operating conditions above 100° C. Further objects of the invention are to provide methods for effective production of such gas-diffusion electrodes and fuel cells for operating temperatures up to 200° C. or even up to 250° C. by using these gas diffusion electrodes.

This object is achieved by providing the embodiments characterized in the claims.

In particular, there is provided, according to the present invention, a gas-diffusion electrode for polymer electrolyte fuel cells with an operating temperature up to 250° C., which electrode has a plurality of gas-permeable, electrically conductive layers, which comprise at least one gas-diffusion layer and one catalyst layer, wherein the catalyst layer contains particles containing ionogenic groups and having a mean particle diameter in the nanometer range.

According to a preferred embodiment, two inventive gas-diffusion electrodes, which comprise at least one gas-diffusion layer and one catalyst layer, with a polymer membrane disposed between the gas-diffusion electrodes in the manner of a sandwich, form a membrane-electrode assembly as shown in FIG. 1. The polymer membrane preferably comprises basic polymers on a polyazole basis, such as polybenzimidazole, and a doping agent selected from the group of sulfonic acids, sulfuric acids, phosphoric acids, phosphonic acids and/or organic derivatives thereof. The catalyst layer contains, preferably in a concentration of less than 50%, particularly preferably less than 40% and most preferably in a concentration of 0.5 to 30% relative to the total weight of support material and electrocatalyst, the electrocatalyst on the support material and at least the particles containing ionogenic groups and having a mean particle diameter in the nanometer range.

As an example, the gas-diffusion electrode according to the present invention with a plurality of gas-permeable, electrically conductive layers may comprise a gas-diffusion layer and a plurality of catalyst layers with different composition.

The gas-diffusion layer is not subject to any particular restriction, but it is preferred that the gas-diffusion layer comprise carbon as the main component. It is particularly preferred that the gas-diffusion layer consist of carbon.

The structure of the gas-diffusion layer is not subject to any particular restriction, but it is preferred that the gas-diffusion layer have the form of paper, fleece, mesh, knitted fabric and/or woven fabric.

In principle, the catalyst layer is not subject to any substantial restriction. as long as it contains particles containing ionogenic groups and having a mean particle diameter in the nanometer range. The inventive gas-diffusion electrode preferably has at least one catalyst layer, which contains particles containing ionogenic groups in amounts of, for example, 0.2 to 50 wt %, particularly preferably 0.5 to 10 wt % relative to the total weight of electrically conductive support material and electrocatalyst.

However, it is preferred that the catalyst layer contain an electrically conductive support material and/or at least part of the particles of an electrically conductive support material of the catalyst layer contain an electrocatalyst.

The electrically conductive support material of the catalyst layer is preferably selected from the group of metals, metal oxides, metal carbides, carbon materials or mixtures thereof.

The carbon materials for the electrically conductive support material of the catalyst layer are not subject to any particular restriction, but it is preferred that carbon black be selected among the carbon materials.

The electrocatalyst described in the foregoing is preferably selected from the group of metals and metal alloys, metals from subgroups 6 and/or 8 of the periodic system of the elements being particularly preferred.

The most preferred metals from subgroups 6 and/or 8 of the periodic system of the elements are the metals platinum and/or ruthenium.

### BRIEF DESCRIPTION OF THE DRAWINGS

FIG. 1 describes a membrane-electrode assembly (MEA), which contains two gas-diffusion electrodes, one an anode and one a cathode, which enclose a proton-conducting electrolyte membrane in the manner of a sandwich and are contacted on the outside by bipolar plates.

FIG. 2 describes a composite of catalyst layer of the cathode and gas-diffusion layer on a polyester film according to Table 2 with addition of particles containing ionogenic groups (see Example 3).

FIG. 3 describes a composite of catalyst layer of the cathode and gas-diffusion layer on a polyester film according to Table 2 without addition of particles containing ionogenic groups (see Comparison Example 1).

FIG. 4 describes a membrane-electrode assembly with liquid electrolyte in the electrode.

FIG. 5 describes a membrane-electrode assembly with nanodisperse distribution of electrolyte and electrocatalyst.

FIG. 6 describes the current-voltage curve at 160° C., 3 bar, H₂ 783 standard mL/min, air 2486 standard mL/min, of Example 5 in comparison with Comparison Example 3.

FIG. 7 describes the variation of the voltage over time under a load of 0.4 A/cm² at 160° C., 3 bar, H₂ 783 standard mL/min, air 2486 standard mL/min, of Example 6 in comparison with Comparison Example 4.

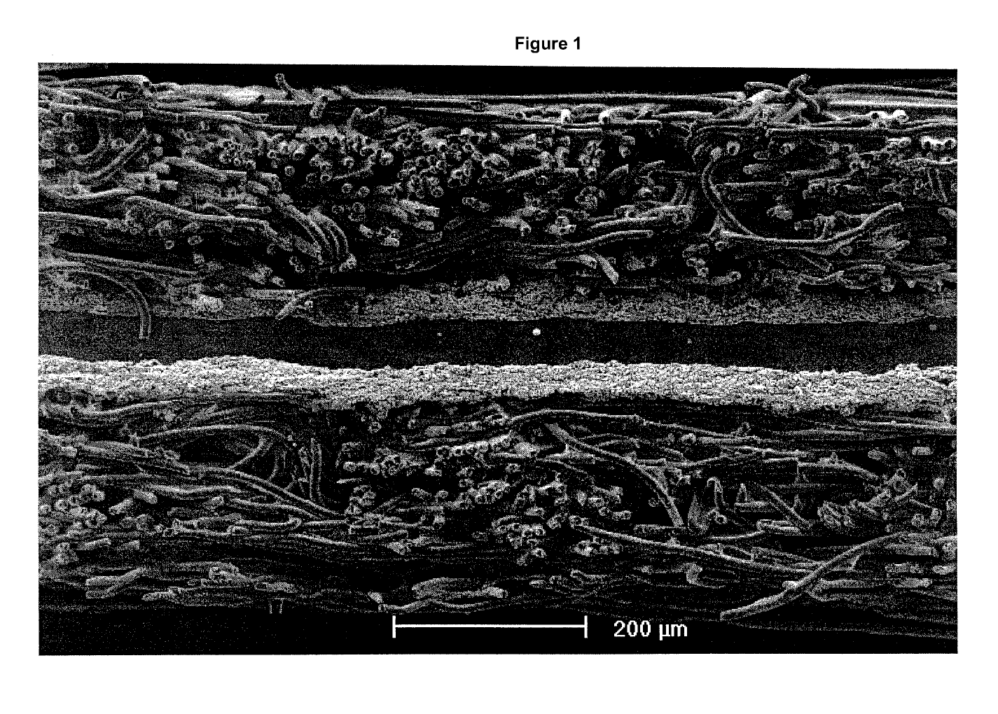

### DETAILED DESCRIPTION

According to the present invention, particles containing ionogenic groups are to be understood in particular as oligomeric and/or polymeric particles, which may but do not necessarily have to exhibit a solid phase boundary with the surrounding matrix of the catalyst layer. Suitable particles containing ionogenic groups are in particular all organic particles composed mainly of one or more organic polymer(s) and/or oligomer(s). In principle, the polymers or oligomers suitable for the organic particles containing ionogenic groups are not subject to any substantial restriction. Nevertheless, it is preferred that the particles containing ionogenic groups are composed mainly of a rubber-like polymer or oligomer or of a non-rubber-like polymer or oligomer, preferably a thermoplastic polymer or oligomer. The particles containing ionogenic groups may be of oligomeric and/or polymeric nature.

As an example, the particles containing ionogenic groups may be composed mainly of base monomers having at least one polymerizable or copolymerizable group, preferably at least two and particularly preferably two to four polymerizable or copolymerizable groups, especially C═C double bonds.

Examples of suitable base monomers, which preferably contain one to four polymerizable or copolymerizable group(s), are butadiene, styrene, acrylonitrile, isoprene, esters of acrylic and methacrylic acid, tetrafluoroethylene, vinylidene fluoride, hexafluoropropene, 2-chlorobutadiene, 2,3-dichlorobutadiene, double-bond-containing carboxylic acids, such as acrylic acid, methacrylic acid, maleic acid or itaconic acid, double-bond-containing sulfonic acids, double-bond-containing phosphonic acids, double-bond-containing hydroxy compounds, such as hydroxyethyl methacrylate, hydroxyethyl acrylate or hydroxybutyl methacrylate, amine-functionalized (meth)acrylates, diisopropenylbenzene, divinylbenzene, divinyl ether, divinyl sulfone, diallyl phthalate, triallyl cyanurate, triallyl isocyanurate, 1,2-polybutadiene, N,N′-m-phenylene maleimide, 2,4-toluylenebis(maleimide) and/or triallyl trimellitate. Base monomers with two to four polymerizable or copolymerizable groups are chosen in particular when efficient cross-linking is desired. Furthermore, the particles containing ionogenic groups may be composed mainly of acrylates and/or methacrylates of preferably polyhydric, particularly preferably dihydric to tetrahydric alcohols, such as ethylene glycol, 1,2-propanediol, butanediol, hexanediol, polyethylene glycol with 2 to 20, preferably 2 to 8 oxyethylene units, neopentyl glycol, bisphenol A, glycerol, trimethylolpropane, pentaerythritol or sorbitol with unsaturated polyesters of aliphatic diols and polyols, and maleic acid, fumaric acid and/or itaconic acid or mixtures thereof.

According to a preferred embodiment, the particles containing ionogenic groups have ionogenic groups on the surface or in the entire particles. Furthermore, it is also possible to use functional groups that can be transformed to ionogenic groups, preferably acid groups, after a chemical reaction, such as a deprotection reaction, a hydrolysis, an addition reaction or a substitution reaction.

The ionogenic groups can be introduced, especially at the surface of the particles, by making reagents that are reactive in particular with C═C double bonds react chemically with reactive groups present at the surface of a cross-linked or pre-cross-linked polymer or oligomer particle. Examples of reagents that can be reacted with reactive groups present at the surface of a cross-linked or pre-cross-linked particle, especially with C═C double bonds, are aldehydes, hydroxy compounds, carboxyl compounds, nitrile compounds, sulfur compounds, such as compounds with mercapto, dithiocarbamate, polysulfide, xanthogenate, thiobenorthiazole and/or dithiophosphonic acid groups, unsaturated carboxylic acids or dicarboxylic acids, unsaturated sulfonic acids, unsaturated phosphonic acids, N,N′-m-phenylenediamine, acrylic acid, methacrylic acid, hydroxyethyl methacrylate, hydroxyethyl acrylate, hydroxybutyl methacrylate, acrylamide, methacrylamide, amine-functionalized (meth)acrylates, such as acrylonitrile, acrolein, N-vinyl-2-pyrrolidone, N-allylurea and N-allylthiourea, and derivatives and mixtures thereof.

Preferably the particles containing ionogenic groups are functionalized at the surface or in the entire particles by ionogenic groups, particularly preferably by covalently bonded acid groups, such as acid groups of monobasic or polybasic acids, acid groups of polybasic acids being particularly preferred. The acid groups bonded covalently at the surface or in the entire particles are preferably carboxylic acid, sulfonic acid, phosphonic acid and/or phosphoric acid groups with one or more acid group(s). However, it is also possible to use other acid groups with similar acidity or functional groups that can be transformed to acid groups. According to a particularly preferred embodiment, the ionogenic groups are selected from one or more of the following functional groups: —COOH, —SO₃H, —OSO₃H, —P(O)(OH)₂, —O—P(OH)₂ and —O—P(O)(OH)₂ and/or salts thereof and/or derivatives thereof, especially partial esters thereof. The salts represent the conjugate bases to the acid functional groups, or in other words —COO⁻, —SO₃⁻, —OSO₃⁻, —P(O)₂(OH)⁻ or —P(O)₃³⁻, —O—P(O)₂²⁻ and —OP(O)₂(OH)⁻ or —OP(O) ₃²⁻ in the form of their metal salts, preferably alkali metal or ammonium salts.

Consequently, the particles containing ionogenic groups may have ionogenic groups at the surface of the particles and form a core-shell type of structure or may contain ionogenic groups in substantially the entire particle, in which case they are functionalized almost homogeneously or throughout.

The ionogenic groups described in the foregoing may be introduced at the surface or in the entire particle by different methods.

However, it is preferable to form particles containing ionogenic groups by copolymerization of at least one of the foregoing base monomers in the presence of at least one monomer having ionogenic groups, preferably acid groups. By this method, which may also be referred to as a one-stage method, it is possible to obtain particles containing not only oligomeric but also polymeric ionogenic groups. Copolymerization in a homogeneous phase, such as in solution or in bulk, is particularly suitable for formation of particles containing oligomeric ionogenic groups with the foregoing ionogenic groups in the entire particle. In the case of copolymerization by emulsion polymerization, for example, or in other words by using an emulsion of a monomer or monomer mixture in water, for example, it is possible to produce in particular particles containing polymeric ionogenic groups, wherein the ionogenic groups are localized preferably on the microgel surface. However, it is also possible to assemble an oligomeric or polymeric particle by starting from a base monomer having suitable ionogenic groups, preferably acid groups or groups that can be transformed to acid groups. For example, it is conceivable, in order to create protein-conducting properties in particular, firstly to obtain an oligomeric or polymeric particle by cross-linking a base monomer containing groups that can be transformed to acid groups, and only thereafter to form the desired ionogenic groups at the surface of the particle by chemical modification, for example by a deprotection reaction, a hydrolysis, an addition reaction or a substitution reaction.

Furthermore, it is preferable firstly to cross-link at least one of the foregoing base monomers in such a way that an oligomer, prepolymer or polymer particle is formed, and thereafter to graft at least one monomer having ionogenic groups, preferably acid groups, onto the surface of this particle, in order to form a structure of the core-shell type. According to this procedure, which corresponds to a two-stage method, particles containing oligomeric or polymeric ionogenic groups can be produced wherein the ionogenic groups are present substantially only on the surface or in a zone near the surface. The procedure in a homogeneous phase, for example in solution or in bulk, is suitable in particular for the formation of particles containing oligomeric ionogenic groups, and the procedure of emulsion polymerization is suitable in particular for the production of particles containing polymeric ionogenic groups. In this connection it is preferable that grafting of a monomer with ionogenic groups achieves a high degree of coverage with the ionogenic groups on the surface of the particle. Preferably the surface of the particle containing ionogenic groups is functionalized almost quantitatively with ionogenic groups, preferably acid groups, which means that substantially every reactive group present on the surface of a cross-linked or pre-cross-linked particle has reacted with a monomer having ionogenic groups.

According to a preferred embodiment, the monomers having ionogenic groups are monomers having acid groups, such as (meth)acrylic acid, maleic acid, vinylsulfonic acid, vinylphosphonic acid and/or styrenesulfonic acid, as well as derivatives and mixtures thereof. According to a particularly preferred embodiment, the ionogenic groups are selected from one or more of the following functional groups: —COOH, —SO₃H, —OSO₃H, —P(O)(OH)₂, —O—P(OH)₂ and —O—P(O)(OH)₂ and/or salts thereof and/or derivatives thereof, especially partial esters thereof. The salts represent the conjugate bases to the acid functional groups, or in other words —COO⁻, —SO₃⁻, —OSO₃⁻, —P(O)₂(OH)⁻ or —P(O)₃³⁻, —O—P(O)₂²⁻ and —OP(O)₂(OH)⁻ or —OP(O)₃²⁻ in the form of their metal salts, preferably alkali metal or aluminum salts.

According to a preferred embodiment, the particles containing ionogenic groups are organic polymers and/or oligomers produced from at least polystyrene and vinylsulfonic acid.

The formation of the particles containing ionogenic groups by polymerization or copolymerization is achieved by standard methods, for example thermal, photochemical or radical methods, if necessary with addition of a radical starter of the peroxide type or azo type. Suitable radical starters of the peroxide type or azo type are known to those skilled in the pertinent art and can be selected as appropriate.

In principle, the particle size of the particles containing ionogenic groups is not subjected to any substantial restriction, as long as it falls within the nanometer range. The particles containing ionogenic groups preferably have a mean particle diameter in a range of 5 nm to 500 nm, a range of 20 nm to 400 nm being particularly preferred and a range of 30 nm to 300 nm being most particularly preferred.

When the particles containing ionogenic groups are of polymeric nature, they may exhibit a solid phase boundary with the surrounding matrix. However, it is also possible that they do not exhibit any solid phase boundary with the surrounding matrix. The particle size of such polymers, which may also be referred to as microgels, lies preferably in a range of approximately 40 nm to approximately 200 nm. These particles containing ionogenic groups are preferably produced by emulsion polymerization.

Emulsion polymerization within the meaning of the present invention is to be understood in particular as a method known in itself, wherein water is used as the reaction medium, in which the monomers used are polymerized in the presence of emulsifiers and radical-forming substances to form aqueous polymer latices (see, among other references, Römpp Lexicon of Chemistry, Volume 2, 10^{th} Edition 1997; P. A. Lovell, M. S. El-Aasser, Emulsion Polymerization and Emulsion Polymers, John Wiley & Sons, ISBN: 0471967467; H. Gerrens, Fortschr. Hochpolym. Forsch. 1, 234 (1959)). In contrast to suspension or dispersion polymerization, emulsion polymerization usually yields finer particles. The finer particles, with their small mean diameter, are smaller than the critical defect size, and so they subject the matrix containing them to only slight mechanical impairments while having a corresponding degree of dispersion.

The choice of monomers is used to adjust the glass transition temperature and the glass transition interval of the polymer particles. The glass transition temperature (Tg) and the glass transition interval (ΔTg) of the microgels or of the substantially spherical polymer particles are determined by differential scanning calorimetry (DSC), preferably as described hereinafter. For this purpose, two cooling/heating cycles are performed for the determination of Tg and ΔTg. Tg and ΔTg are determined in the second heating cycle. For the determinations, approximately 10-12 mg of the selected microgel is placed in a DSC sample holder (standard aluminum pan) of Perkin-Elmer. The first DSC cycle is performed by cooling the sample first with liquid nitrogen to −100° C. and then heating to +150° C. at a rate of 20 K/min. The second DSC cycle is begun by cooling the sample immediately, as soon as a sample temperature of +150° C. has been reached. Cooling is achieved by rapid cooling with liquid nitrogen. In the second heating cycle, the sample is heated to +150° C. once again, as in the first cycle. The heating rate in the second cycle is again 20 K/min. Tg and ΔTg are determined graphically on the DSC curve of the second heating operation. For this purpose, three lines are fitted to the DSC curve. The first line is constructed along the curve part of the DSC curve below Tg, the second line is constructed along the curve branch with inflection point passing through Tg, and the third line is constructed along the curve branch of the DSC curve above Tg. In this way three lines with two points of intersection are obtained. Each of the two points of intersection represents a characteristic temperature. The glass transition temperature Tg is obtained as the mean value of these two temperatures, and the glass transition interval ΔTg is obtained from the difference between the two temperatures.

Rubber-like polymer particles exhibit a glass temperature of generally lower than 23° C. Thermoplastic polymer particles generally have a glass transition temperature higher than 23° C.

For the polymer particles used according to the invention, the glass transition interval is preferably broader than 5° C., preferably broader than 10° C.

Rubber-like polymer particles are preferably particles based on conjugated dienes, such as butadiene, isoprene, 2-chlorobutadiene and 2,3-dichlorobutadiene, as well as ethene, esters of acrylic and methacrylic acid, vinyl acetate, styrene or derivatives thereof, acrylonitrile, acrylamides, methacrylamides, tetrafluoroethylene, vinylidene fluoride, hexafluoropropene, double-bond-containing hydroxy compounds, such as hydroxyethyl methacrylate, hydroxyethyl acrylate, hydroxypropyl acrylate, hydroxybutyl methacrylate, acrolein or combinations thereof.

Preferred monomers or monomer combinations include: butadiene, isoprene, acrylonitrile, styrene, α-methylstyrene, chloroprene, 2,3-dichlorobutadiene, butyl acrylate, 2-ethylhexyl acrylate, hydroxyethyl methacrylate, tetrafluoroethylene, vinylidene fluoride and hexafluoropropene.

Here, “based on” means that preferably more than 60 wt % of the polymer particles consists of the cited monomers, preferably more than 70 wt % and more preferably more than 90 wt %.

The polymer particles may be cross-linked or non-cross-linked. Cross-linked polymer particles are also referred to as microgels or substantially spherical polymer particles. In particular, the polymer particles may be particles based on homopolymers or statistical copolymers. The terms homopolymers and statistical copolymers are known to those skilled in the art and, for example, are explained in Vollmert, Polymer Chemistry, Springer Verlag 1973.

As the polymer base of the rubber-like, cross-linked or non-cross-linked particles containing ionogenic groups there can be used in particular:
BR: polybutadiene,
ABR: butadiene/acrylic acid C₁₋₄-alkyl ester copolymers,
IR: polyisoprene,
SBR: statistical styrene-butadiene copolymers with styrene contents of 1-60, preferably 5-50 wt %,
FKM: fluoro rubber,
ACM: acrylate rubber,
NBR: polybutadiene-acrylonitrile copolymers with acrylonitrile contents of 5-60, preferably 10-60 wt %,
CR: polychloroprene,
EAM: ethylene/acrylate copolymers,
EVM: ethylene/vinyl acetate copolymers.

Inventive, non-rubber-like, especially thermoplastic polymer particles expediently have a glass transition temperature Tg higher than 23° C. For the thermoplastic polymer particles, the glass transition interval is preferably broader than 5° C. (where Tg or the glass transition interval is determined as described hereinabove). Non-rubber-like, especially thermoplastic polymer particles are preferably particles based on methacrylates, especially methyl methacrylate, styrene or styrene derivatives, such as α-methylstyrene, para-methylstyrene, acrylonitrile, methacrylonitrile, vinylcarbazole or combinations thereof. Here, “based on” means that preferably more than 60 wt % of the polymer particles consists of the cited monomers, preferably more than 70 wt % and more preferably more than 90 wt %.

More preferred thermoplastic polymer particles are particles based on methacrylates, especially methyl methacrylate, styrene, a-methylstyrene and acrylonitrile.

The polymer particles preferably have an approximately spherical geometry.

The polymer particles used according to the invention preferably have a mean particle diameter in the range of 5 nm to 500 nm, particularly preferably of 20 nm to 400 nm, most preferably of 30 nm to 300 nm. The mean particle diameter is determined by means of ultracentrifugation with the aqueous latex of the polymer particles from the emulsion polymerization. The method yields a mean value for the particle diameter that allows for the possible presence of agglomerates (H. G. Müller (1996) Colloid Polymer Science 267; 1113-1116 as well as W. Scholtan, H. Lange (1972) Kolloid-Z and Z Polymere 250: 782). Ultracentrifugation has the advantage that the entire particle-size distribution is characterized and different mean values such as number-average mean and weight-average mean can be calculated from the distribution curve.

The mean diameter values used according to the invention are obtained by a determination of diameter by means of dynamic light scattering. It is also performed on the latex. Lasers operating at 633 nm (red) and 532 nm (green) are commonly used. In contrast to ultracentrifugation, dynamic light scattering yields not the entire particle-size distribution but instead a mean value in which large particles are weighted disproportionately.

The polymer particles used according to the invention preferably have a weight-average mean particle diameter in the range of 5 nm to 500 nm, preferably of 20 nm to 400 nm, particularly preferably of 30 nm to 300 nm.

The inventive particles containing ionogenic groups can be produced by emulsion polymerization, in which case the particle size is adjusted within a wide diameter range by variation of the starting materials, such as emulsifier concentration, initiator concentration, liquor ratio of organic to aqueous phase, ratio of hydrophilic to hydrophobic monomers, amount of cross-linking monomers, polymerization temperature, etc.

After the polymerization, the latices can be treated by vacuum distillation or by treatment with superheated steam, in order to separate volatile components, especially unreacted monomers.

The polymer particles produced in this way can be further processed, for example by evaporation, by electrolyte coagulation, by co-coagulation with a further latex polymer, by freeze-coagulation (see U.S. Pat. No. 2,187,146) or by spray drying.

In a preferred embodiment, the particles containing ionogenic groups and produced by emulsion polymerization are at least partly cross-linked.

Cross-linking of the particles containing ionogenic groups and produced by emulsion polymerization is achieved preferably by the addition of polyfunctional monomers during polymerization, such as by the addition of compounds having at least two, preferably 2 to 4 copolymerizable C═C double bonds, such as diisopropenylbenzene, divinylbenzene, divinyl ether, divinylsulfone, diallyl phthalate, triallyl cyanurate, triallyl isocyanurate, 1,2-polybutadiene, N,N′-m-phenylene maleimide, 2,4-tolulenebis(maleimide), triallyl trimellitate, acrylates and methacrylates of polyhydric, preferably dihydric to tetrahydric C₂₋₁₀ alcohols, such as ethylene glycol, 1,2-propanediol, butanediol, hexanediol, polyethylene glycol having 2 to 20, preferably 2 to 8 oxyethylene units, neopentyl glycol, bisphenol A, glycerol, trimethylolpropane, pentaerythritol, sorbitol as well as unsaturated polyesters from aliphatic diols and polyols and maleic acid, fumaric acid and/or itaconic acid.

Cross-linking of the polymer particles containing ionogenic groups may be achieved directly during emulsion polymerization, such as by copolymerization with cross-linking multifunctional compounds or by subsequent cross-linking as described hereinafter. Direct cross-linking during emulsion polymerization is preferred. Preferred multifunctional comonomers are compounds having at least two, preferably 2 to 4 copolymerizable C═C double bonds, such as diisopropenylbenzene, divinylbenzene, divinyl ether, divinylsulfone, diallyl phthalate, triallyl cyanurate, triallyl isocyanurate, 1,2-polybutadiene, N,N′-m-phenylene maleimide, 2,4-tolulenebis(maleimide) and/or triallyl trimellitate. Other compounds that come into consideration are the acrylates and methacrylates of polyhydric, preferably dihydric to tetrahydric C₂₋₁₀ alcohols, such as ethylene glycol, 1,2-propanediol, butanediol, hexanediol, polyethylene glycol having 2 to 20, preferably 2 to 8 oxyethylene units, neopentyl glycol, bisphenol A, glycerol, trimethylolpropane, pentaerythritol, sorbitol with unsaturated polyesters of aliphatic diols and polyols as well as maleic acid, fumaric acid and/or itaconic acid.

Cross-linking during emulsion polymerization may also take place by prolonging the polymerization up to high conversions or, in the monomer-feed method, by polymerization with high internal conversions. Another possibility also consists in performing the emulsion polymerization in the absence of regulators.

For cross-linking of the non-cross-linked or weakly cross-linked polymer particles following emulsion polymerization, it is best to use the latices that are obtained during emulsion polymerization.

Examples of suitable cross-linking chemicals are organic peroxides, such as dicumyl peroxide, t-butyl cumyl peroxide, bis(t-butylperoxyisopropyl)benzene, di-t-butyl peroxide, 2,5-dimethylhexane-2,5-dihydroperoxide, 2,5-dimethylhexyne-3,2,5-dihydroperoxide, dibenzoyl peroxide, bis-(2,4-dichlorobenzoyl)peroxide, t-butyl perbenzoate as well as organic azo compounds, such as azobisisobutyronitrile and azobiscyclohexanenitrile as well as dimercapto and polymercapto compounds, such as dimercaptoethane, 1,6-dimercaptohexane, 1,3,5-trimercaptotriazine and mercapto-terminated polysulfide rubbers, such as mercapto-terminated reaction products of bis-chloroethyl formal with sodium polysulfide.

The optimal temperature for performing post-cross-linking naturally depends on the reactivity of the cross-linking agent, and it may range from temperatures such as room temperature to approximately 180° C., if necessary at elevated pressure (in this regard see Houben-Weyl, Methods of Organic Chemistry, 4^{th} Edition, Volume 14/2, page 848). Particularly preferred cross-linking agents are peroxides.

Cross-linking of rubbers containing C═C double bonds to microgels may also be achieved in dispersion or emulsion with simultaneous, partial or if necessary complete hydrogenation of the C═C double bond, as described in U.S. Pat. No. 5,302,696 or U.S. Pat. No. 5,442,009 or if necessary other hydrogenating agents, such as organometal hydride complexes.

If necessary, particle growth by agglomeration may be performed before, during or after post-cross-linking.

The particles containing cross-linked ionogenic groups and used according to the invention expediently have toluene-insoluble fractions (gel content) at 23° C. of at least approximately 70 wt %, more preferably at least approximately 80 wt %, even more preferably at least approximately 90 wt %. This toluene-insoluble fraction is determined in toluene at 23° . For this purpose, 250 mg of the polymer particles is swollen for 24 hours with shaking in 25 mL toluene at 23° C. After centrifugation at 20000 rpm, the insoluble fraction is separated and dried. The gel content is obtained from the quotient of the dried residue and the initial weight and is reported in wt %.

The polymer particles containing cross-linked ionogenic groups and used according to the invention further expediently have a swelling index in toluene at 23° C. of less than approximately 80, more preferably of less than 60, even more preferably of less than 40. Thus the swelling indices (Qi) of the polymer particles may lie particularly preferably between 1-15 and 1-10. The swelling index is calculated from the weight of the solvent-containing polymer particles swollen in toluene for 24 hours at 23° C. (after centrifugation at 20000 rpm) and the weight of the dried polymer particles:

Qi=wet weight of the polymer particles/dry weight of the polymer particles.

To determine the swelling index, 250 mg of the polymer particles is allowed to swell for 24 hours with shaking in 25 mL toluene. The gel is centrifuged off and weighed, then dried to constant weight at 70° C. and weighed once again.

The polymer particles containing ionogenic groups and used according to the invention contain ionogenic groups that are ionic or are capable of forming ionic groups. In this way they are capable of being proton-donating and/or proton-accepting.

According to a preferred embodiment, the ionogenic groups are acid groups. According to a particularly preferred embodiment, the ionogenic groups are selected from one or more of the following functional groups: —COOH, —SO₃H, —OSO₃H, —P(O)(OH)₂, —O—P(OH)₂ and —O—P(O)(OH)₂ and/or salts thereof and/or derivatives thereof, especially partial esters thereof. The salts represent the conjugate bases to the acid functional groups, or in other words —COO⁻, —SO₃⁻, —OSO₃⁻, —P(O)₂(OH)⁻ or —P(O)₃³⁻, —O—P(O)₂²⁻ and —OP(O)₂(OH)⁻ or —OP(O)₃²⁻ in the form of their metal salts, preferably alkali metal or ammonium salts.

According to the invention, particularly preferred ionogenic groups within the meaning of the invention are selected from —SO₃H, —PO(OH)₂, —O—P(O)(OH)₂ and/or salts thereof and/or derivatives thereof, especially partial esters thereof.

Depending on the production technique, the ionogenic groups may be located on the surface and/or not on the surface.

The ionogenic groups may be introduced into the polymer particles by incorporation of functionalized monomers during polymerization and/or by modification after polymerization.

As examples, functionalized monomers are selected from the group consisting of: acrylic acid, methacrylic acid, vinylbenzoic acid, itaconic acid, maleic acid, fumaric acid, crotonic acid, vinylsulfonic acid, styrenesulfonic acid, monomers containing phosphonic acid or phosphoric acid groups and having polymerizable C═C double bonds, such as vinylphosphonic acid, 2-phosphonomethylacrylic acid and 2-phosphonomethylacrylic acid amide, phosphonic acid or phosphoric acid esters of hydroxyfunctional monomers having polymerizable C═C double bonds or salts or derivatives thereof.

Phosphoric acid esters of hydroxyfunctional monomers having polymerizable C═C double bonds preferably have the following formulas (I) or (II) of the following methacrylate compounds:

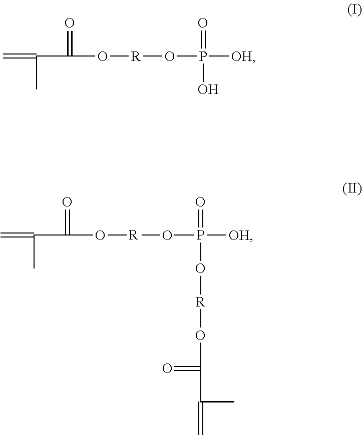

in which R is a divalent organic group, especially such as C₁₋₁₀ alkylene. Preferably R is a C₂₋₄ alkylene group (or in other words a C₂₋₄ alkandiyl group), such as an ethylene or an n-propylene group. Salts of these compounds are also usable, especially such as alkali metal salts, preferably the sodium salt or ammonium salts. The corresponding acrylates are also usable. Furthermore, partial esters with other saturated or unsaturated carboxylic acids of these compounds may be used. According to the invention, the term partial ester includes both the case that some of the acid hydroxyl groups of the ionogenic group are partly esterified and the case in which some of the hydroxyl groups in the polymer particles are esterified while others are not esterified.

The proportion of the functional monomers incorporated by polymerization and containing ionogenic groups is preferably 0.1 to 100 wt %, more preferably 0.2 to 99.5 wt % relative to the total amount of monomers. This means that homopolymers of these monomers containing ionogenic groups may also be used. For example, at least 10 wt %, at least 20 wt % or at least 30 wt % of these monomers may be present.

As an example, the ionogenic groups —OSO₃H and —OP(O)(OH)₂ may also be introduced into the polymer particles by reaction of hydroxyl-modified polymer particles (such as obtained by incorporation of hydroxyalkyl (meth)acrylates by polymerization) or by addition of sulfuric or phosphoric acid to epoxy-containing (for example, glycidyl methacrylate-containing) polymer particles with sulfuric acid or phosphoric acid, by addition of sulfuric acid or phosphoric acid to double-bond-containing polymer particles, by decomposition of persulfates or perphosphates in the presence of double-bond-containing polymer particles, as well as by transesterification after polymerization. Furthermore, the —SO₃H and —P(O)(OH)₂ groups may also be introduced by sulfonation or phosphonation of aromatic vinyl polymers.

Furthermore, ionogenic groups may also be produced by reaction of hydroxyl-modified polymer particles with correspondingly functionalized epoxides.

Besides the cited ionogenic groups, further functional groups for control of the properties may be introduced in particular into the surface of the polymer particles, such as by chemical reaction of the already cross-linked polymer particles with chemicals having reactivity toward C═C double bonds. These reactive chemicals are in particular compounds with which polar groups such as aldehyde, hydroxyl, carboxyl, nitrile, etc., as well as sulfur-containing groups, such as mercapto, dithiocarbamate, polysulfide, xanthogenate and/or dithiophosphoric acid groups and/or unsaturated dicarboxylic acid groups may be chemically bonded to the polymer particles. The goal of modification is in particular to improve the compatibility with a matrix material, into which the proton-conducting polymer particles can be incorporated, and to control the wetting properties of the catalyst layer.

Particularly preferred methods of modification are grafting of the polymer particles with functional monomers as well as reaction with low molecular weight agents. In this way the ionogenic, proton-donating or proton-accepting monomers may also be incorporated into the polymer particles if necessary.

The starting point for grafting of the polymer particles with functional monomers is expediently the aqueous microgel dispersion, which is reacted with polar monomers such as vinylsulfonic acid, styrenesulfonic acid, acrylic acid, methacrylic acid, itaconic acid, hydroxyethyl (meth)acrylate (in the present Application, the term “(meth)acrylate” includes both methacrylate and acrylate), hydroxypropyl (meth)acrylate, hydroxybutyl (meth)acrylate, acrylonitrile, acrylamide, methacrylamide, acrolein, monomers containing phosphonic acid or phosphoric acid groups and having polymerizable C═C double bonds, such as vinylphosphonic acid, 2-phosphonomethylacrylic acid and 2-phosphonomethylacrylic acid amide, phosphonic acid or phosphoric acid esters of hydroxyfunctional monomers having polymerizable C═C double bonds or salts or derivatives thereof, especially such as partial esters thereof, under the conditions of radical emulsion polymerization. In this way polymer particles having core-shell morphology are obtained. It is desirable that the monomer used in the modification step be grafted as quantitatively as possible onto the unmodified polymer particles or microgel. Expediently, the functional monomers are added before complete cross-linking of the microgels. Modification of double-bond-containing polymer particles, for example by ozonolysis, is also an option.

In a preferred embodiment, the polymer particles, especially the microgels, are modified by hydroxyl groups, especially also at the surface thereof. The hydroxyl group content of the polymer particles, especially of the microgels, is determined according to DIN 53240, as the hydroxyl number in units of mg KOH/g polymer, by reaction with acetic anhydride and titration of the liberated acetic acid with KOH. The hydroxyl number of the polymer particles, especially of the microgels, preferably lies between 0.1 and 100, more preferably between 0.5 and 50 mg KOH/g polymer.

The amount of modification agent used is contingent on its effectiveness and on the requirements applicable to the individual case, and it lies in the range of 0.05 to 30 weight per cent relative to the total amount of polymer particles and especially microgel used. A value of 0.5 to 10 weight per cent relative to the total amount of polymer particles, especially microgel, is particularly preferred.

The modification reactions may be performed at temperatures of 0 to 180° C., preferably 20 to 95° C., if necessary under a pressure of 1 to 30 bar. The modifications may be carried out on rubber microgels in bulk or in the form of a dispersion thereof, in which case inert organic solvents or even water may be used as the reaction medium. Particularly preferably, the modification is performed in an aqueous dispersion of the cross-linked rubber.

The amount of particles containing ionogenic groups in the catalyst layer is not subject to any substantial restriction. Nevertheless, it is preferable that the catalyst layer contain the particles containing ionogenic groups in amounts of 0.2 to 50 wt %, particularly preferably 0.5 to 10 wt % relative to the total weight of electrically conductive support material and electrocatalyst.

The distribution, in the catalyst layer, of particles containing ionogenic groups may be varied as desired. Nevertheless, it is preferable that the particles containing ionogenic groups be homogeneously distributed in the catalyst layer.

Preferably, the particles containing ionogenic groups are composed mainly of one or more organic polymers and/or oligomers.

Preferably, the particles containing ionogenic groups are composed mainly of a rubber-like polymer or oligomer or a non-rubber-like polymer or oligomer, preferably a thermoplastic polymer or oligomer.

The particles containing ionogenic groups have, preferably at the surface or in the entire particles, ionogenic groups, especially covalently bound acid groups, the acid groups particularly preferably being carboxylic acid, sulfonic acid, sulfuric acid, phosphonic acid and/or phosphoric acid groups.

According to a preferred embodiment of the present invention, the particles containing ionogenic groups are organic polymers and/or oligomers produced from at least styrene and vinylsulfonic acid.

The particles containing ionogenic groups preferably have a mean particle diameter in a range of 5 nm to 500 nm.

The particles containing ionogenic groups preferably have a substantially spherical or substantially stellate form. Preferably, the particles containing ionogenic groups are solid particles.

According to a preferred embodiment of the present invention, the particles containing ionogenic groups are produced by emulsion polymerization.

Furthermore, there is provided a method for production of the inventive gas-diffusion electrode for polymer electrolyte fuel cells with an operating temperature up to 250° C. and with a plurality of gas-permeable, electrically conductive layers, which comprise at least one gas-diffusion layer and one catalyst layer, wherein the catalyst layer contains particles containing ionogenic groups and having a mean particle diameter in the nanometer range, which method comprises the following steps:

A) producing, in a (suitable) solvent, a suspension of at least one particulate, electrically conductive support material for the catalyst layer, wherein at least one part of the particles supports an electrocatalyst, and of the particles containing ionogenic groups and having a mean particle diameter in the nanometer range,

B) forming the suspension in an electrode mold on a (suitable) backing, such as a membrane, a gas-diffusion layer or an inert substrate,

C) drying the electrode mold from step B) on the backing, and

D) transferring the electrode mold from step C) into a membrane-electrode assembly.

To carry out step (A), the particulate, electrically conductive support material for the catalyst layer, which material supports an electrocatalyst at least partly, is provided preferably as a powder, particularly preferably as a nanodisperse powder. Support materials known by the designation Carbon Black, such as Vulcan XC or Shawnigan Black, have proved particularly suitable as support materials. The support material, coated at least partly with catalyst, is preferably suspended in water. The particles containing ionogenic groups are preferably provided in the form of a microgel dispersion. This can then be added to water, for example, after which the mixture is united with isopropanol and suspended by stirring.

Within the scope of the inventive method, it is preferably provided that the particulate, electrically conductive support material for the catalyst layer is provided as a suspension or paste, and/or the forming of the catalyst layer in the electrode mold is carried out by applying the suspension or paste on at least one backing, followed by drying.

Within the scope of the inventive method, it is advantageously possible to use a gas-diffusion layer, a polymer electrolyte membrane or an inert substrate as backing.

According to a preferred embodiment of the present invention, the particles containing ionogenic groups are added in step B) in amounts of 0.2 to 50 wt %, particularly preferably 0.5 to 10 wt % relative to the total weight of the electrically conductive support material and the electrocatalyst.

Preferably, step B) may be achieved by a printing process, such as the inkjet process. Thereby catalyst layers with a thickness of 10 to 200 μm, preferably 10 to 100 μm and most preferably 10 to 50 μm can be produced on a suitable backing. An electrolyte membrane, the gas-diffusion layer or an inert substrate may be used as the backing.

In the case of use of a gas-diffusion layer, the production of the gas-diffusion electrode is already complete after the end of drying step (C). In the case of use of an electrolyte membrane, the catalyst layers are preferably applied on both sides. In the case of use of an inert substrate, the catalyst layer, while still in moist form, is usually covered subsequently with a gas-diffusion layer and delivered to step (C).

Step (C) preferably takes place at temperatures in the range of 100 to 200° C. in a stream of nitrogen. In the case of use of an inert substrate, the substrate is removed from the gas-diffusion electrode after completion of the drying step.

Step (D) preferably takes place by hot pressing with application of pressure and temperature. To produce the membrane-electrode assembly, the gas-diffusion electrodes from step (C) are impregnated with phosphoric acid, combined with the electrolyte membrane and hot-pressed. In the case of use of a catalyst-coated membrane from step (C), this is combined with two gas-diffusion layers impregnated with phosphoric acid and hot-pressed to the membrane-electrode assembly. In the membrane-electrode unit, the gas-diffusion layer and catalyst layer form the gas-diffusion electrode.

Steps (B) to (D) may be carried out either in stationary manner or else as part of a continuous manufacturing process.

In other respects, it is also particularly preferred in the scope of the inventive method when
the particles containing ionogenic groups are composed mainly of one or more organic polymer(s) and/or oligomer(s),
the particles containing ionogenic groups are composed mainly of a rubber-like polymer or oligomer or of a non-rubber-like polymer or oligomer, preferably a thermoplastic polymer or oligomer,
the particles containing ionogenic groups have ionogenic groups, preferably covalently bound acid groups, on the surface or in the entire particles,
wherein the acid groups are preferably carboxylic acid, sulfonic acid, sulfuric acid, phosphonic acid and/or phosphoric acid groups,
the particles containing ionogenic groups are organic polymers and/or oligomers produced from at least styrene and vinylsulfonic acid,
the particles containing ionogenic groups have a mean particle diameter in a range of 5 nm to 500 nm,
the particles containing ionogenic groups preferably have a substantially spherical or substantially stellate form,
the particles containing ionogenic groups are solid particles,

and/or
the particles containing ionogenic groups are produced by emulsion polymerization.

According to the present invention, a polymer electrolyte fuel cell for operation at temperatures up to 250° C. is provided with gas-diffusion electrodes that contain a plurality of gas-permeable, electrically conductive layers, which comprise at least one gas-diffusion layer and one catalyst layer, wherein the catalyst layer contains particles containing ionogenic groups and having a mean particle diameter in the nanometer range.

The polymer electrolyte fuel cell with an operating temperature up to 250° C. preferably contains a doping agent and a basic polymer from the group comprising polybenzimidazole, polypyridine, polypyrimidine, polyimidazole, polybenzthiazole, polybenzoxazole, polyoxadiazole, polyquinoxaline, polythiadiazole, poly(tetrapyrene) or a combination of two or more thereof.

In the polymer electrolyte fuel cell, the doping agent is preferably selected from the group comprising phosphoric acid, phosphoric acid derivatives, phosphonic acid, phosphonic acid derivatives, sulfuric acid, sulfuric acid derivatives, sulfonic acid, sulfonic acid derivatives or a combination of two or more thereof.

The polymer electrolyte fuel cell with an operating temperature up to 250° C. preferably contains an electrode with an electrolyte selected from the group comprising phosphoric acid, phosphoric acid derivatives, phosphonic acid, phosphonic acid derivatives, sulfuric acid, sulfuric acid derivatives, sulfonic acid, sulfonic acid derivatives or a combination of two or more thereof.

The particles containing ionogenic groups are preferably acid-functionalized and have proton-conducting and surface-active properties, to the effect that, when the particles are used in the catalyst layer, the liquid electrolyte can be distributed with good wetting of the catalyst layer in the electrode. The surface-active properties of the particles also bring about good adherence between the catalyst support material, the gas-diffusion layer and/or the polymer membrane in mechanically stable membrane-electrode assemblies (MEA), and so the use of perfluorinated additives such as PTFE as binders is not necessary. Because of the acid functionalization of the ionogenically functionalized particles, the binding capacity of the catalyst layer for the liquid electrolytes is increased. Because the use of additionally binding additives such as PTFE is avoided, there are obtained electrodes with hydrophilic properties which—compared with unmodified membrane-electrode assemblies—exhibit greater power and also have high long-term stability in operation of the fuel cells.

The particles functionalized with ionogenic groups have a mean particle diameter in the nanometer range, can be dispersed in catalyst inks and in this way permit the use of printing processes (“inkjet processes”) for production of gas-diffusion electrodes, so that catalyst layers with a thickness of <50 μm can be achieved for little technical outlay. The avoidance of fluorine-containing binding additives such as PTFE further ensures that the noble-metal component of the membrane-electrode assemblies being used can be subsequently recycled without problems.

According to a preferred embodiment, there are provided, for fuel cells, inventive gas-diffusion electrodes that each comprise at least one gas-diffusion layer and one catalyst layer, which contact a polymer membrane disposed between them in the manner of a sandwich, wherein the catalyst layer contains particles functionalized with ionogenic groups and having a mean particle diameter in the nanometer range in a concentration of less than 40% relative to the total weight of support material and electrocatalyst.

Furthermore, according to the present invention, there is provided the use of an inventive gas-diffusion electrode in polymer electrolyte fuel cells with an operating temperature up to 250° C.

### EXAMPLES

### Example 1

### Production of a Microgel Dispersion

The microgel dispersion used for production of the inventive gas-diffusion electrodes was produced by means of emulsion polymerization in conformity with Example 1, pp. 29-30 of DE 102007011424.0. To achieve the emulsion polymerization, 3.93 kg water was introduced into a 6-liter glass reactor with stirrer and purged with a stream of nitrogen. Now 24.2 g Mersolat® H95 (sodium salt of a mixture of long-chain C₁₆-C₁₈ alkylsulfonates, Lanxess Deutschland GmbH) as part of the total Mersolat amount of 26.3 g was introduced into the water in the water-containing receiver and dissolved. Then 1000 g of a mixture consisting of 88.5 wt % styrene (98%, from KMF Labor Handels GmbH), 10 wt % sodium styrenesulfonate (90%, from Fluka, product number 94904) as well as 1.5% trimethylolpropane trimethacrylate (90%, from Aldrich, product number: 2468-0) together with 0.08 g 4-methoxyphenol (Arcos Organics, article No. 126001000, 99%) was introduced into the reaction vessel. The reaction mixture was heated to 30-40° C. then freshly prepared 4% aqueous premix solution was added. The premix solution consisted of: 0.169 g ethylenediaminetetraacetic acid (Fluka, article No. 03620), 0.135 g iron(II) sulfate 7H₂O (Riedel de Haen, article number 12354, calculated without water of crystallization), 0.347 g Rongalit C, Na formaldehyde sulfoxylate (Merck-Schuchardt, article number 8.06455, calculated without water of crystallization) as well as 0.524 g trisodium phosphate 12H₂O (Acros, article number 206520010, calculated without water of crystallization). For activation of polymerization, an activator solution of 0.56 g methane hydroperoxide (Trigonox NT 50, Akzo-Degussa) in 50 g water plus the remaining amount of Mersolat® H95 (2.1 g) was prepared. Half of the aqueous activator solution was added to the reaction vessel 5 minutes after addition of the premix solution. Hereby the polymerization was started. After a reaction time of 2.5 hours, the reaction temperature was raised to 40-50° C. After one further hour, the second half of the aqueous activator solution was added. Once a polymer conversion >90% (usually: 95-100%) was reached, the polymerization was stopped by addition of an aqueous solution of 2.35 g dihydroxylamine (DEHA, Aldrich, article number 03620). Once the polymerization reaction was stopped, unreacted monomers and volatile components were removed from the latex by stripping with steam. The solid content of the suspension in water was 18.66 wt %. In addition, 4 wt % of anionic emulsifier was obtained.

### Example 2

### Production of Gas-Diffusion Electrodes for the Anode

100 g of a catalyst-coated support material (40% Pt/Vulcan XC-72, Cabot Co.) was suspended in 405.9 g water until complete wetting of the catalyst. To this mixture there was added 26 g 60% polytetrafluoroethylene (PTFE) suspension in water (TF5032N, Dyneon Co.), then the mixture was united with 405.9 g isopropanol and stirred at 9500 rpm for 40 minutes by means of an UltraTurrax ultrathorax stirrer (IKA T-25). The resulting suspension was printed by means of an inkjet system (EBS-1500, EBS Ink-Jet System Co.) at the center of a 50 cm² square area of a polymer electrolyte membrane of polybenzimidazole (PBI) measuring 102.9 cm². The membrane coated with the catalyst layer was dried for 2 hours at 120° C. in a stream of nitrogen. The finished membrane-anode composite had a platinum surface density of 0.48 mg/cm² on the electrode side.

### Example 3

### Production of Gas-Diffusion Electrodes for the Cathode with Nanoparticles

8.41 g of a catalyst-coated support material (40% Pt/Vulcan XC-72, Cabot Co.) was suspended in 38.06 g water until complete wetting of the catalyst. To this suspension there was added 0.90 g microgel dispersion (0.17 g nanoparticles in water, produced according to Example 1), then the mixture was united with 38.06 g isopropanol and stirred at 9500 rpm for 10 minutes by means of an UltraTurrax ultrathorax stirrer (IKA T-25). Using the finished suspension, a 50 cm² square area was printed by means of an inkjet system (EBS-1500, EBS Ink-Jet System Co.) on a polyester film (Pütz Co., 100 μm) and placed on a 50 cm² square section of a 200 μm thick gas-diffusion layer of type H2315 of the Freudenberg Co. The gas-diffusion layer coated with the catalyst layer was dried for 2 hours at 120° C. in a stream of nitrogen and the polyester film was peeled off. The finished gas-diffusion electrode had a microgel proportion of 2.0 wt % as well as a platinum surface density of 2.19 mg/cm².

### Comparison Example 1

### Production of Gas-Diffusion Electrodes for the Cathode Without Nanoparticles

8.41 g of a catalyst-coated support material (40% Pt/Vulcan XC-72, Cabot Co.) was suspended in 56.84 g water until complete wetting of the catalyst. Then the mixture was united with 55.74 g isopropanol and stirred at 9500 rpm for 10 minutes by means of an UltraTurrax ultrathorax stirrer (IKA T-25). Using the finished suspension, a 50 cm² square area was printed by means of an inkjet system (EBS-1500, EBS Ink-Jet System Co.) on a polyester film (Pütz Co., 100 μm) and placed on a 50 cm² square section of a 200 μm thick gas-diffusion layer of type H2315 of the Freudenberg Co. The gas-diffusion layer coated with the catalyst layer was dried for 2 hours at 120° C. in a stream of nitrogen and the polyester film was peeled off. The finished gas-diffusion electrode had a platinum surface density of 2.16 mg/cm².

Table 1 provides an overview of the formulas for production of the cathodes. The properties of the produced gas-diffusion electrodes are summarized in Table 2.

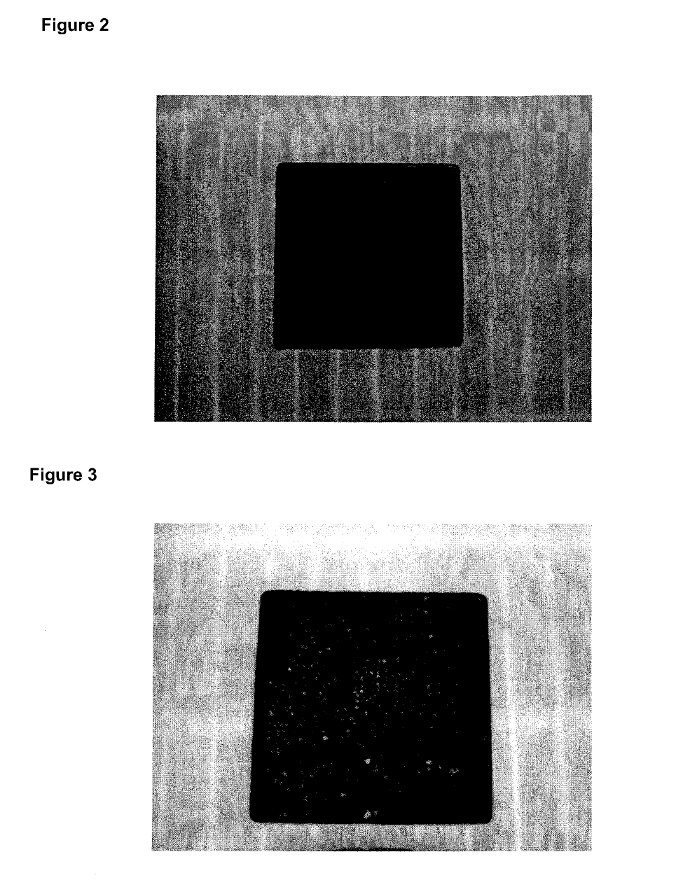

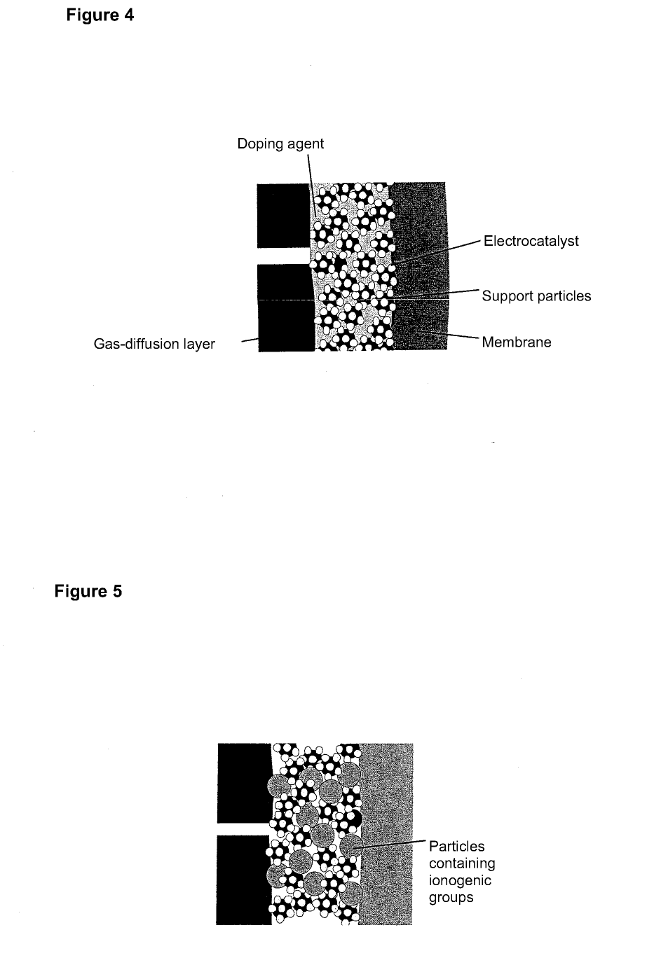

The cathode containing 2.0 wt % nanoparticles has a homogeneous appearance and, together with the gas-diffusion layer on a polyester film as an inert support, forms a homogeneous composite (see FIG. 2), whereas an electrode consisting exclusively of catalyst and gas-diffusion layer without nanoparticle addition on support material (polyester film) has a fragmented appearance and can be easily detached from the gas diffusion layer (see FIG. 3).

### Example 4

### Production of a Membrane-Electrode Assembly (MEA) Containing a Gas-Diffusion Electrode with Nanoparticles from Example 3

To produce an MEA, a 50 cm² square area from the gas-diffusion electrode of the cathode according to Example 3 was impregnated with 0.406 g phosphoric acid (85%). A 50 cm² square area of a 200 μm thick gas-diffusion layer of type H2315 of the Freudenberg Co. was impregnated with 0.328 g phosphoric acid (85%) and placed with the electrode side on the center of the anode-membrane composite (thickness of the PBI membrane 37 μm) according to Example 2, while the gas-diffusion electrode of the cathode previously impregnated with phosphoric acid was placed with the electrode side on the center of the membrane side. The entire membrane-electrode sandwich was pressed together for 5 hours 30 minutes at 180° C. with a compression force of 5 kN to obtain an MEA. The MEA obtained in this way had a thickness of 516 μm and was capable of being installed in fuel cells.

### Comparison Example 2

### Production of a Membrane-Electrode Assembly (MEA) Containing a Gas-Diffusion Electrode Without Nanoparticles from Comparison Example 1

To produce an MEA, a 50 cm² square area from the gas-diffusion electrode of the cathode according to Comparison Example 1 was impregnated with 0.373 g phosphoric acid (85%). A 50 cm² square area of a 200 μm thick gas-diffusion layer of type H2315 of the Freudenberg Co. was impregnated with 0.348 g phosphoric acid (85%) and placed with the electrode side on the center of the anode-membrane composite (thickness of the PBI membrane 34 μm) according to Example 2, while the gas-diffusion electrode of the cathode previously impregnated with phosphoric acid was placed with the electrode side on the center of the membrane side. The entire membrane-electrode sandwich was pressed together for 5 hours 30 minutes at 180° C. with a compression force of 5 kN to obtain an MEA. The MEA obtained in this way had a thickness of 516 μm and was capable of being installed in fuel cells.

### Example 5

### Determination of the Voltage-Current Characteristic of a Fuel Cell Containing an MEA, Produced According to Example 4, with Nanoparticles in the Gas-Diffusion Electrode

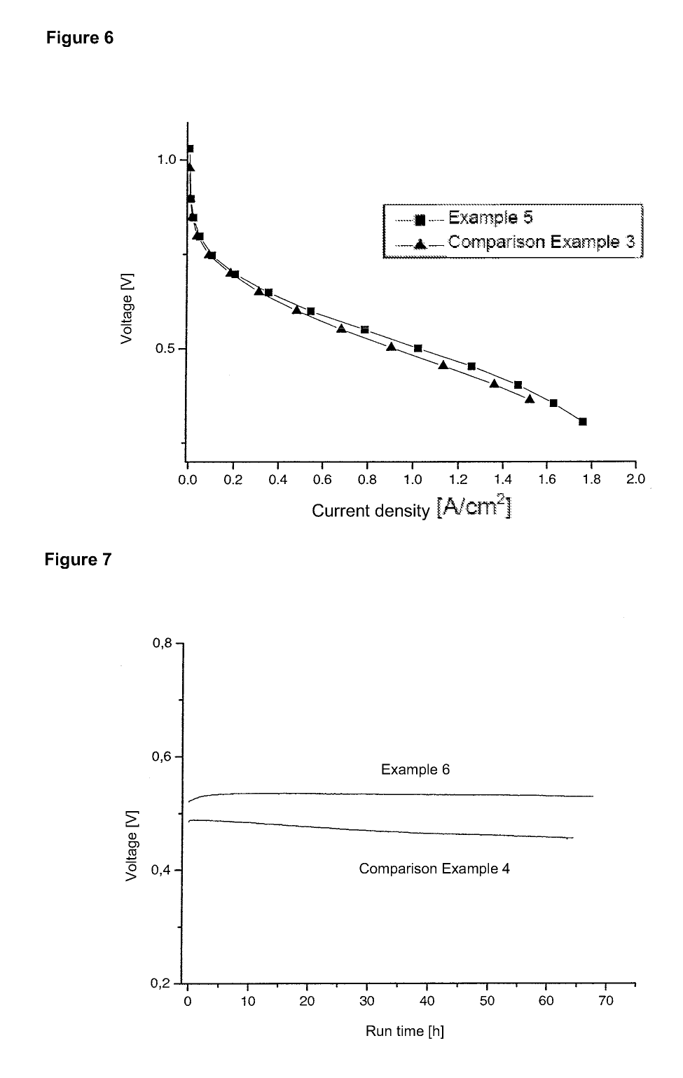

The MEA produced according to Example 4 was installed in a test fuel cell of Fuel Cell Technology, Inc. and sealed with a compression pressure of 15 bar. FIG. 6 shows the shape of a current-voltage curve for the fuel cell at an operating temperature of 160° C. The gas flow for H₂ was 783 standard mL/min and for air was 2486 standard mL/min. Non-humidified gases were used. The power parameters were determined on an FCATS Advanced Screener of Hydrogenics, Inc. The maximum power was measured as 0.33 W/cm² at a current density of 0.6 A/cm². The cell impedance was 0.22 Ωcm².

### Comparison Example 3

### Determination of the Voltage-Current Characteristic of a Fuel Cell Containing an MEA, Produced According to Comparative Example 2, Without Nanoparticles in the Gas-Diffusion Electrode

The MEA produced according to Comparison Example 2 was installed in a test fuel cell of Fuel Cell Technology, Inc. and sealed with a compression pressure of 15 bar. FIG. 6 shows the shape of a current-voltage curve for the fuel cell at an operating temperature of 160° C. The gas flow for H₂ was 783 standard mL/min and for air was 2486 standard mL/min. Non-humidified gases were used. The power parameters were determined on an FCATS Advanced Screener of Hydrogenics, Inc. The maximum power was measured as 0.29 W/cm² at a current density of 0.6 A/cm². The cell impedance was 0.20 Ωcm².

Compared with the gas-diffusion cathode without nanoparticles according to Comparison Example 3, the inventive gas-diffusion electrode according to Example 5 exhibits a higher open-circuit voltage at zero current as well as a higher power over the entire voltage range.

### Example 6

### Determination, in the Long-Time Test at Constant Load, of the Power of a Fuel Cell Containing an MEA, Produced According to Example 5, with Nanoparticles in the Gas-Diffusion Electrode

The MEA produced according to Example 4 was installed in a test fuel cell of Fuel Cell Technology, Inc. and sealed with a compression pressure of 15 bar. FIG. 7 shows the shape of a current-voltage curve for the fuel cell under a load of 0.4 A/cm² at an operating temperature of 160° C. over 70 hours. The gas flow for H₂ was 783 standard mL/min and for air was 2486 standard mL/min. Non-humidified gases were used. The power parameters were determined on an FCATS Advanced Screener of Hydrogenics, Inc. After 70 hours at 0.4 A/cm² no voltage drop was determined.

### Comparison Example 4

### Determination, in the Long-Time Test at Constant Load, of the Power of a Fuel Cell Containing an MEA, Produced According to Comparison Example 2, Without Nanoparticles in the Gas-Diffusion Electrode

The MEA produced according to Comparison Example 2 was installed in a test fuel cell of Fuel Cell Technology, Inc. and sealed with a compression pressure of 15 bar. FIG. 7 shows the shape of a current-voltage curve for the fuel cell under a load of 0.4 A/cm² at an operating temperature of 160° C. over 70 hours. The gas flow for H₂ was 783 standard mL/min and for air was 2486 standard mL/min. Non-humidified gases were used. The power parameters were determined on an FCATS Advanced Screener of Hydrogenics, Inc. The voltage drop measured 533 μV/h at 0.4 A/cm².

Compared with the gas-diffusion cathode without nanoparticles according to Comparison Example 4, the inventive gas-diffusion cathode according to Example 6 exhibits, due to the stabilizing influence of the nanoparticles on the electrode structure, a voltage drop under a load of 0.4 A/cm² that is smaller by a factor of ten over a longer period of operation.

### Example 7

### Determination of the Change in Surface Activity of the Electrolyte Due to Nanoparticles

50 g 85 wt % phosphoric acid was mixed with 2.68 g of the microgel dispersion produced according to Example 1 (microgel content 0.5 g) and the surface tension, determined by means of the contact angle method with Wilhelmi plate on a K12 tensiometer (Krüss Co.), was found to be 38 dyn/cm² at room temperature. The comparison value for pure 85 wt % phosphoric acid is 80 dyn/cm², thus proving the lowering of the surface tension and thus the improvement of the wetting properties by the presence of microgel components in 85 wt % phosphoric acid.

By virtue of this lowered surface tension of phosphoric acid in the two-component system of phosphoric acid and microgel dispersion, it is possible to explain the improved wettability of the inventive gas-diffusion electrodes with phosphoric acid and the improved power density of the inventive gas-diffusion electrodes.

TABLE 1
Formulas of the cathodes

| | | | | Microgel | Microgel | Microgel |
|---|---|---|---|---|---|---|
| | 40% Pt/VXC | Water | Isopropanol | suspension | amount | content |
| | [g] | [g] | [g] | [g] | [g] | [wt %] |
| Example 3 | 8.41 | 38.06 | 38.06 | 0.90 | 0.17 | 2.0 |
| Comparison | 8.41 | 56.84 | 55.74 | — | — | — |
| Example 1 | | | | | | |

TABLE 2
Influence of nanoparticles on the properties of the cathodes

| | | Adherence | | Microgel |
|---|---|---|---|---|
| | Pt Loading | of electrode | | content |
| | [mg/cm²] | on GDL | Homogeneity | [wt %] |
| Example 3 | 2.19 | yes | yes (see FIG. 2) | 2.0 |
| Comparison | 2.16 | no | fragmented | — |
| Example 1 | | | (see FIG. 3) | |

We claim:

1. A gas-diffusion electrode for polymer electrolyte fuel cells with an operating temperature up to 250° C., wherein said electrode comprises a plurality of gas-permeable electrically conductive layers, wherein each gas-permeable electrically conductive layer comprises at least one gas-diffusion layer and at least one catalyst layer, wherein the catalyst layer comprises ionogenic-group-containing particles, and wherein the ionogenic-group-containing particles have a mean particle diameter in the nanometer range.

2. The gas-diffusion electrode of claim 1, wherein the catalyst layer comprises an electrically conductive support material.

3. The gas-diffusion electrode of claim 2, wherein the electrically conductive support material is a particulate electrically conductive support material.

4. The gas-diffusion electrode of claim 2, wherein the electrically conductive support material comprises electrocatalyst-containing particles.

5. The gas-diffusion electrode of claim 2, wherein the electrically conductive support material is selected from the group consisting of metals, metal oxides, metal carbides, carbon materials and a combination of two or more thereof.

6. The gas-diffusion electrode of 5, wherein the electrically conductive support material is carbon black.

7. The gas-diffusion electrode of claim 4, wherein the electrocatalyst is selected from the group consisting of metals, metal alloys, and combinations thereof.

8. The gas-diffusion electrode of claim 7, wherein the metals are selected from the group consisting of subgroup 6 of the periodic system of elements, subgroup 8 of the periodic system of elements, and a combination of two or more thereof.

9. The gas-diffusion electrode of claim 7, wherein the metals are selected from the group consisting of platinum, ruthenium, and combinations thereof.

10. The gas-diffusion electrode of claim 1, wherein the gas-diffusion layer comprises carbon.

11. The gas-diffusion electrode of claim 1, wherein the gas-diffusion layer consists essentially of carbon.

12. The gas-diffusion electrode of claim 1, wherein the gas-diffusion layer comprises a material selected from the group consisting of paper, fleece, mesh, knitted fabric, woven fabric, and a combination of two or more thereof.

13. The gas-diffusion electrode of claim 4, wherein at least one catalyst layer comprises ionogenic-group-containing-particles in an amount within the range of from about 0.2 to about 50 wt % relative to a total weight of electrically conductive support material and electrocatalyst.

14. The gas-diffusion electrode of claim 13, wherein at least one catalyst layer comprises ionogenic-group-containing-particles in an amount within the range of from about 0.5 to about 10 wt %, relative to a total weight of electrically conductive support material and electrocatalyst.

15. The gas-diffusion electrode according of claim 1, wherein the ionogenic-group-containing particles comprise a material selected from the group consisting of organic polymers, organic oligomers, and a combination of two or more thereof.

16. The gas-diffusion electrode according of claim 1, wherein the ionogenic-group-containing particle comprises a material selected from the group consisting of rubber-like polymers, rubber-like oligomers, thermoplastic polymers, thermoplastic oligomers, and a combination of two or more thereof.

17. The gas-diffusion electrode of claim 1, wherein the ionogenic-group-containing particles comprise covalently bound acid groups.

18. The gas-diffusion electrode of claim 17, wherein the ionogenic-group-containing particles comprise acid groups attached to the outer surface of the ionogenic-group-containing particles.

19. The gas-diffusion electrode of claim 17, wherein the acid groups are selected from the group consisting of carboxylic acid, sulfonic acid, sulfuric acid, phosphonic acid, phosphoric acid, and a combination of two or more thereof.

20. The gas-diffusion electrode of claim 15, wherein the organic polymers comprise at least one styrene monomer and at least one vinylsulfonic acid monomer.

21. The gas-diffusion electrode of claim 15, wherein the organic oligomers comprise at least one styrene monomer and at least one vinylsulfonic acid monomer.

22. The gas-diffusion electrode of claim 1, wherein the ionogenic-group-containing particles have a mean particle diameter within a range of from about 5 nm to about 500 nm.

23. The gas-diffusion electrode of claim 1, wherein the ionogenic-group-containing particles have a substantially spherical or substantially stellate form.

24. The gas-diffusion electrode of claim 1, wherein the ionogenic-group-containing particles are solid particles.

25. The gas-diffusion electrode of claim 1, wherein the ionogenic-group-containing particles are produced by emulsion polymerization.

26. A method for production of a gas-diffusion electrode for polymer electrolyte fuel cells with an operating temperature up to 250° C., wherein said electrode comprises a plurality of gas-permeable electrically conductive layers, wherein each gas-permeable electrically conductive layer comprises at least one gas-diffusion layer and at least one catalyst layer, wherein the catalyst layer comprises ionogenic-group-containing particles, and wherein the ionogenic-group-containing particles have a mean particle diameter in the nanometer range, which method comprises:
A) producing, in a suitable solvent, a suspension comprising (1) at least one particulate, electrically conductive support material for the catalyst layer, wherein at least a portion of said particulate, electrically conductive support material comprises an electrocatalyst, and (2) ionogenic-group-containing particles, wherein the ionogenic-group-containing particles have a mean particle diameter in the nanometer range;
B) forming the suspension in an electrode mold on a backing;
C) drying the suspension in the electrode mold of step (B) on the backing; and
D) transferring the electrode mold of step (C) into a membrane-electrode assembly.

27. The method of claim 26, wherein the particulate, electrically conductive support material is provided as a powder.

28. The method of claim 26, wherein the particulate, electrically conductive support material is provided as a suspension and the forming of the catalyst layer in the electrode mold is carried out by applying the suspension on at least one backing, followed by drying.

29. The method of claim 26, wherein the particulate, electrically conductive support material is provided as a paste, and the forming of the catalyst layer in the electrode mold is carried out by applying the paste on at least one backing, followed by drying.

30. The method of claim 26, wherein the backing is selected from the group consisting of a gas-diffusion layer, a polymer electrolyte membrane, and an inert substrate.

31. The method of claim 26, wherein the ionogenic-group-containing particles are added in step (B) in an amount within the range of from about 0.2 to about 50 wt %, relative to a total weight of the electrically conductive support material and the electrocatalyst.

32. The method of claim 31, wherein the ionogenic-group-containing particles are added in step (B) in an amount within the range of from about 0.5 to about 10 wt %, relative to a total weight of the electrically conductive support material and the electrocatalyst.

33. The method of claim 26, wherein the ionogenic-group-containing particles are provided as a microgel dispersion.

34. The method of claim 26, wherein the ionogenic-group-containing particles comprise a material selected from the group consisting of organic polymers, organic oligomers, and a combination of two or more thereof.

35. The method of claim 26, wherein ionogenic-group-containing particles comprise a material selected from the group consisting of rubber-like polymers, rubber-like oligomers, thermoplastic polymers, thermoplastic oligomers, and a combination of two or more thereof.

36. The method of claim 26, wherein the ionogenic-group-containing particles comprise covalently bound acid groups.

37. The method of claim 36, wherein the ionogenic-group-containing particles comprise acid groups attached to the outer surface of the ionogenic-group-containing particles.

38. The method of claim 36, wherein the acid groups are selected from the group consisting of carboxylic acid, sulfonic acid, sulfuric acid, phosphonic acid, phosphoric acid, and a combination of two or more thereof.

39. The method of claim 26, wherein the ionogenic-group-containing particles comprise an organic polymer comprising at least one styrene monomer and at least one vinylsulfonic acid monomer.

40. The method of claim 26, wherein the ionogenic-group-containing particles comprise an organic oligomer comprising at least one styrene monomer and at least one vinylsulfonic acid monomer.

41. The method of claim 26, wherein the ionogenic-group-containing particles have a mean particle diameter within the range of from about 5 nm to about 500 nm.

42. The method of claim 26, wherein the ionogenic-group-containing particles have a substantially spherical or substantially stellate form.

43. The method of claim 26, wherein the ionogenic-group-containing particles are solid particles.

44. The method of claim 26, wherein the ionogenic-group-containing particles are produced by emulsion polymerization.

45. A polymer electrolyte fuel cell for operation at temperatures up to 250° C. comprising a gas-diffusion electrode, said electrode comprising a plurality of gas-permeable, electrically conductive layers, wherein each gas-permeable electrically conductive layer comprises at least one gas-diffusion layer and at least one catalyst layer, wherein the catalyst layer comprises ionogenic-group-containing particles, and wherein the ionogenic-group-containing particles have a mean particle diameter in the nanometer range.

46. The polymer electrolyte fuel cell of claim 45, further comprising a doping agent and a basic polymer selected from the group consisting of polybenzimidazole, polypyridine, polypyrimidine, polyimidazole, polybenzthiazole, polybenzoxazole, polyoxadiazole, polyquinoxaline, polythiadiazole, poly(tetrapyrene), and a combination of two or more thereof.

47. The polymer electrolyte fuel cell of claim 46, wherein the doping agent is selected from the group consisting of phosphoric acid, phosphoric acid derivatives, phosphonic acid, phosphonic acid derivatives, sulfuric acid, sulfuric acid derivatives, sulfonic acid, sulfonic acid derivatives, and a combination of two or more thereof.

48. The polymer electrolyte fuel cell of claim 47, further comprising an electrode comprising an electrolyte selected from the group consisting of phosphoric acid, phosphoric acid derivatives, phosphonic acid, phosphonic acid derivatives, sulfuric acid, sulfuric acid derivatives, sulfonic acid, sulfonic acid derivatives, and a combination of two or more thereof.

49. A method for generating an electric current comprising contacting a polymer electrolyte fuel cell comprising the gas-diffusion electrode of claim 1 with fuel and an oxidizing agent.

50. The method of claim 49, where the fuel is hydrogen gas and the oxidizing agent is oxygen gas.
